(19) United States
(12) Patent Application Publication
(10) Pub. No.: US 2022/0412115 A1
(43) Pub. Date: Dec. 29, 2022

(54) FLOOR-TO-CEILING MOUNTING POST FOR ELECTRICAL EQUIPMENT

(71) Applicant: Yunex Limited, Dorset (GB)

(72) Inventor: Simon White, Dorset (GB)

(73) Assignee: Yunex Limited, Dorset (GB)

(21) Appl. No.: 17/853,402

(22) Filed: Jun. 29, 2022

(30) Foreign Application Priority Data
Jun. 29, 2021 (GB) 2109344.8

(51) Int. Cl. E04H 12/22; E04H 12/18

(52) U.S. Cl. CPC E04H 12/22; E04H 12/182

(57) ABSTRACT

A mounting post of variable length that may be attached between a local floor and ceiling. The mounting post may include a cable access hole near respective upper and lower extremities of the mounting post.

### CROSS REFERENCE TO RELATED APPLICATIONS

This patent application claims priority to Great Britain (GB) Patent Application No. 2109344.8, filed Jun. 29, 2021, which is incorporated herein by reference in its entirety.

### BACKGROUND

### Field

The present disclosure relates to floor-to-ceiling mounts for electrical equipment, including mounts that may be employed in multi-story car parks for mounting chargers for electric vehicles.

### Related Art

Currently, AC chargers for electric vehicles are typically provided with one of three mounting options. Floor mount, post mount or wall mount. DC chargers are usually much larger and heavier than AC chargers so are floor mounted in their own cabinet.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIGS. 1A and 1B illustrate conventional chargers for electric vehicles and their mounting posts.

FIG. 2 illustrates a multi-story car park equipped with a charger for electric vehicles mounted according to an exemplary embodiment of the present disclosure.

FIGS. 3-11 illustrate various views of a mounting system according to an exemplary embodiment of the present disclosure.

The exemplary embodiments of the present disclosure will be described with reference to the accompanying drawings. Elements, features and components that are identical, functionally identical and have the same effect are — insofar as is not stated otherwise — respectively provided with the same reference character.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, and components have not been described in detail to avoid unnecessarily obscuring embodiments of the disclosure.

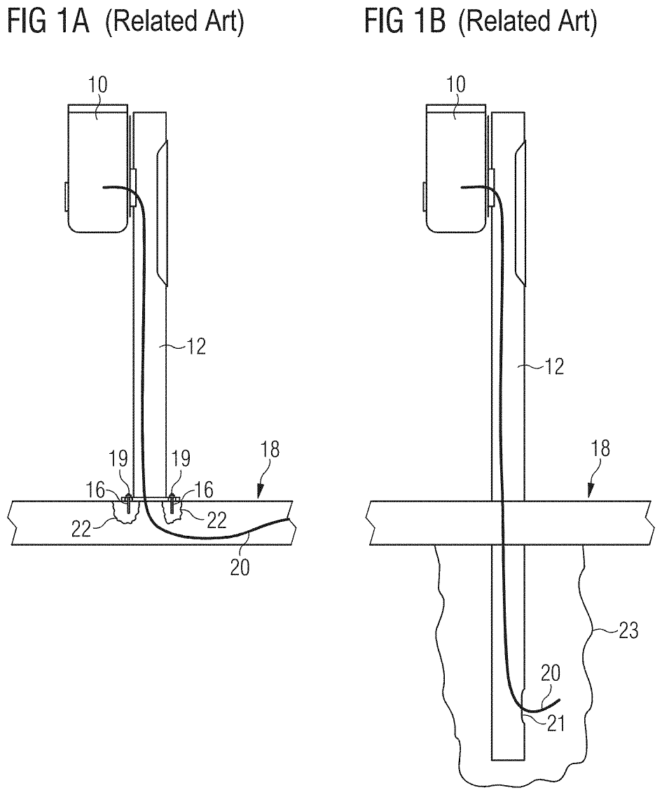

FIG. 1A illustrates a conventional AC charger 10 for electric vehicles, mounted to a flange post. FIG. 1B illustrates a conventional AC charger mounted to a straight post. These are two typical designs of EV charger post: flange mount or straight post. The flange post, such as shown in FIG. 1A, is usually about 1.5 m high with a flanged base 14 with holes 16 for mounting to a ground surface 18 using fasteners 19. Cabling 20 to the charger is usually subterranean with the cables coming up inside the post from a hole in the ground between the mounting fixings 22. The straight post, such as shown in FIG. 1B, pierces the ground surface 18 and is buried to a depth back filled with concrete 23 to support the post. Cable entry is subterranean through a hole 21 in the post, this same technique is used for street lighting columns. Such posts are typically rounded, rectangular or square in cross-sectional profile and are usually made of steel, aluminum, or stainless steel and galvanized or powder coated for corrosion protection where necessary. Other materials may of course be used if appropriate.

Current policies of national and regional governments, and public opinion, contribute to a rising demand for charging points for charging of electric vehicles. While issues arise also in respect of charging electrically powered buses, lorries and other vehicles, the present disclosure particularly relates to private motor cars.

Since private motor cars became widely available in the 1950s, infrastructure has built up to enable car drivers to park their cars at will in popular locations such as town centers, shopping centers, airports, railway stations and so on. Multi-story car parks provide improved use of available land than a simple surface car park and have become widespread. Over the years, changes in architectural style and changes in building regulations have meant that multi story car parks are not standardized in dimensions and layout, but almost all multi-story car parks are essentially composed of floor and roof slabs, ramps, external walls and supporting pillars, all of which are typically made from steel-reinforced concrete, or simply from steel. Visible walls may be clad in brick or some other aesthetically pleasing material. Driving surfaces may be coated in a top dressing used in road building, such as tarmacadam or resin-bonded grit, for all-weather grip. Nonetheless, most car parks have several design features in common. They have multiple floors, and a roof, supported by pillars; external walls are largely open to admit light and provide ventilation. Typically, each floor is provided with a low-height wall of about 1.0-1.2 m height, to inhibit users from falling; on the inside of these low walls, a crash barrier is typically provided, often of rolled steel, to reduce the likelihood of vehicle damage to the low-height walls.

The largely open-sided design of these car parks is to promote ventilation and light ingress, meaning that they typically do not have solid external walls of sufficient height to allow chargers for electric vehicles to be mounted.

Typically, chargers for electric vehicles are installed on support columns either directly secured or with bespoke clamps. Any suitable walls are also used.

Post mount chargers tend to have quite large posts and require excavation for both the cables and sometimes even the post. This is not practical in multi-story car parks of steel or concrete floor slabs. Freestanding chargers or post chargers are discouraged due to the damage caused by installing these to the concrete slab and excavation required.

It is difficult to mount wall chargers to the steel or concrete supporting pillars of a typical multi-story car park, as these are for structural purposes and shouldn't be drilled into. They are also typically scarce: the designer of the car park will have aimed to minimize the number of supporting pillars, to facilitate parking.

An object of the present disclosure is to provide a mount which may be used in such circumstances to mount equipment, such as chargers for electric vehicles. The disclosure may be applied to equipment other than chargers for electric vehicles, and to environments other than multi-story car parks, although the present disclosure is thought to have particular application to such installations.

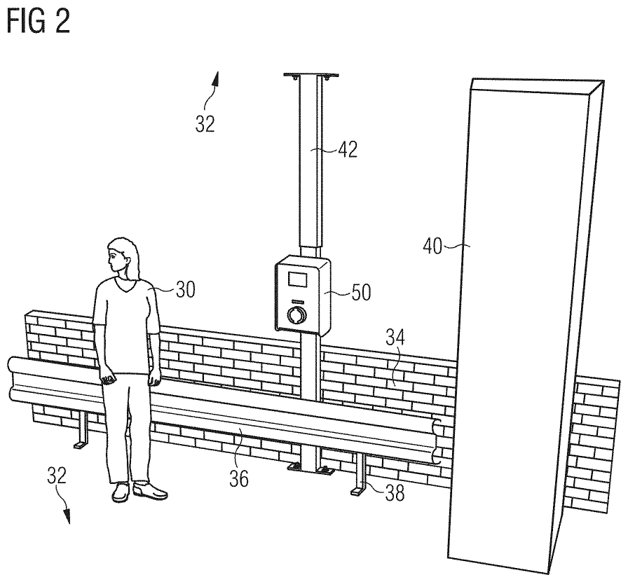

FIG. 2 schematically illustrates a view of a multi-story car park equipped with a charger for electric vehicles mounted according to an embodiment of the present disclosure.

A user 30 is illustrated for scale, but the disclosure is not limited to thereto. As described above, the multi-story car park comprises floor slabs 32 above and below the user, typically of steel-reinforced concrete. A low wall 34 is provided at the edge of the floor slab 32 to reduce the chance of a user 30 falling from the car park. To reduce the chance of damage to the low wall 34 by vehicles using the car park, a crash barrier 36 is provided, separated from the wall by a certain distance and mounted to a floor slab 32 by posts 38. Such posts are typically attached by drilling into the floor slab and bolting the post 38 in place. A support pillar 40 is also illustrated and may be formed by a simple steel I-beam.

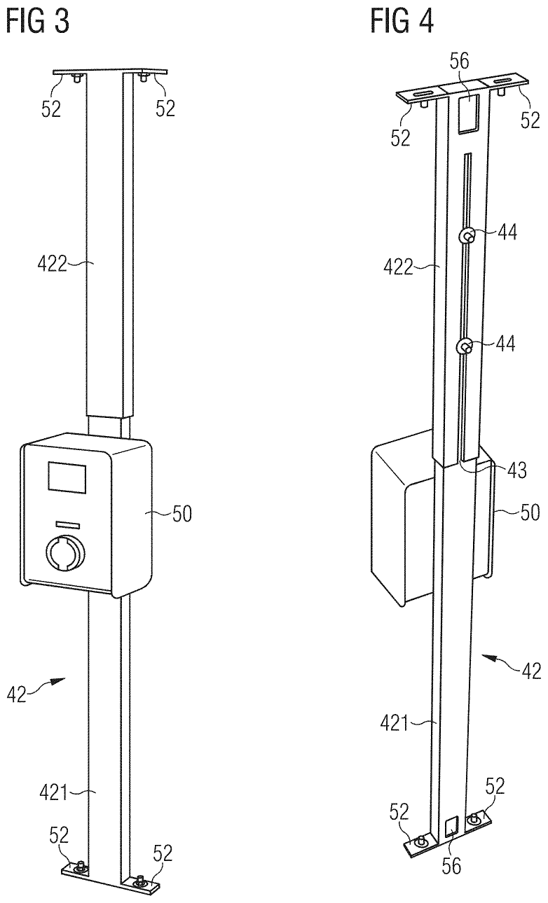

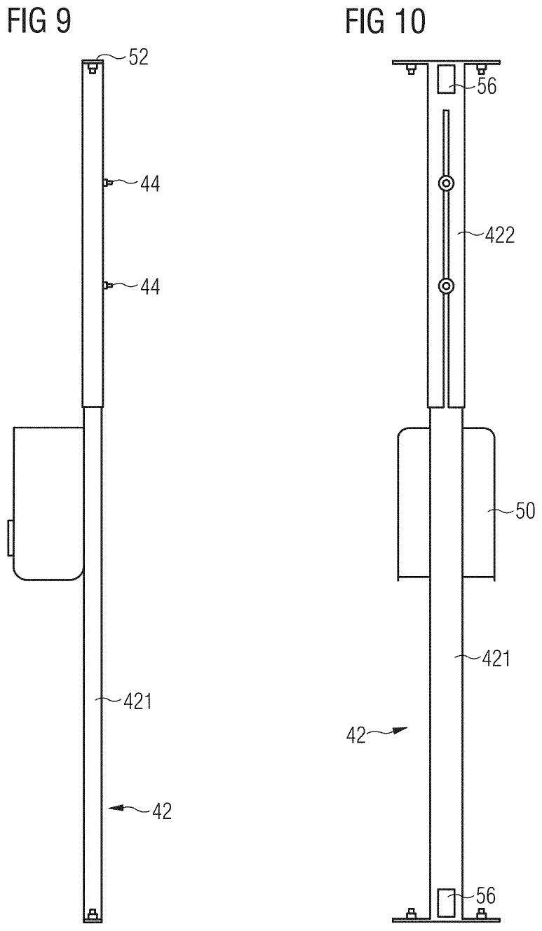

FIGS. 3, 8, 9 respectively show perspective, front and side views of a mounting post 42 and charger 50, of an installation using an embodiment of the present disclosure.

In the illustrated embodiment, the present disclosure provides a slim mounting post 42 that may be mounted between the crash barrier 36 and the low wall 34, and may carry a charger 50 for electric vehicles, and/or other equipment as required.

Often in car parks, it is preferred to cable to the ceiling of the car park, as cables can be allowed to run over the surface of the ceiling, sheathed and/or in conduit as required, whereas they would not be allowed to run over the surface of the floor. Cables may also be supported by ceiling mounted cable trays. The illustrated embodiment includes a mounting post 42 that bridges the local ceiling to floor gap, and contacts both the floor and the ceiling. This allows for robust attachment of the mounting post top and bottom, and permits internal cabling from the ceiling, which facilitates routing of cables. It may be found possible to run cabling from a floor below, externally of the wall 34 then through a hole in wall 34, upwards through mounting post 42 to a floor above by similar routing. Where the post 42 is mounted near to a wall the rear lower cable hole could be used with the cable clipped directly to the wall.

Multi-story car parks do not meet any set standards for ceiling to floor height, so the mounting post 42 of the disclosure is adjustable for different ceiling to floor heights.

As best seen in FIGS. 4, 7 and 10, the mounting post 42 comprises two hollow sections 421 and 422. As shown, lower section 421 is essentially a continuous rectangular profile, while upper section 422 has a slot 43 on one side, typically the rear side, that is, the side that faces away from a user of the mounted equipment 50. Of course, other configurations are possible. In the illustrated embodiment, the upper section 422 is of larger internal cross-sectional dimensions than lower section 421, and so lower section 421 can slide into upper section 422. This enables the overall height of the mounting post 42 to be adjusted to match the floor to ceiling height of the intended installation location.

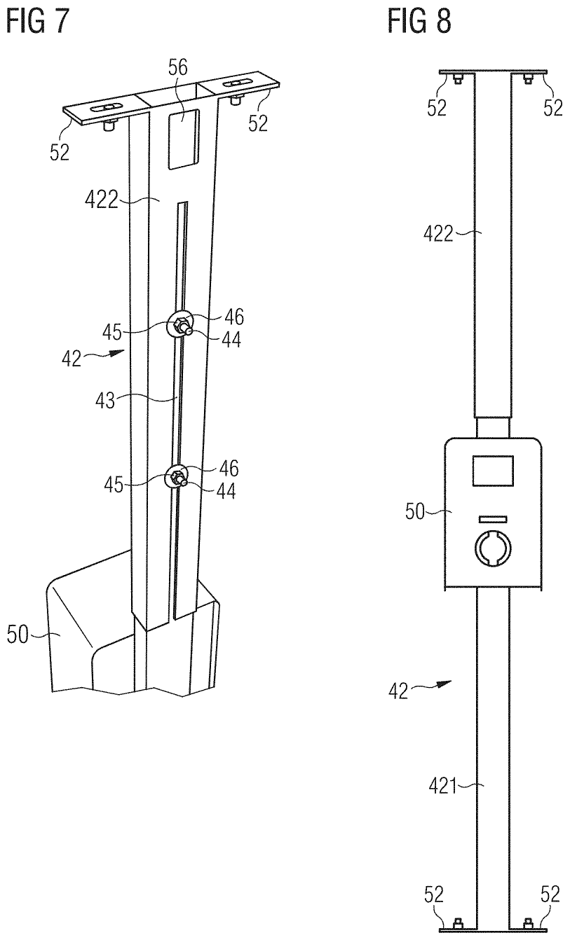

As illustrated in FIGS. 4 and 7, captive bolts or studs 44 are provided, attached to lower section 421 and protrude through slot 43 in upper section 422 when lower section 421 slides within upper section 422. The positions of upper and lower sections may be reversed, but an installation as shown is more resistant to rainwater ingress into the mounting post. In an exemplary embodiment, a nut 45, accompanied by a washer 46, may be placed on some or each of the captive bolts or studs 44 and tightened to fix the overall height of the mounting post 42. Of course, other means such as ratcheting tabs, spot welding, crimping, may be used to fix the height of the mounting post 42.

The mounting post 42 braces the gap between floor and ceiling, providing a solid structure on which to mount a charger 50. The charger 50 is conventional in itself.

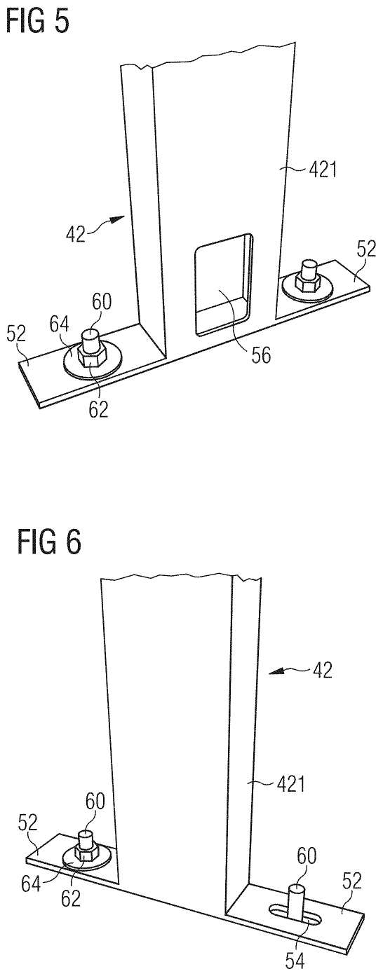

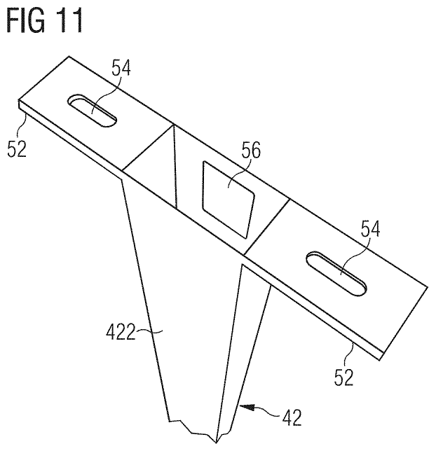

Protrusions or brackets 52 are provided at upper and lower extremities of the mounting post 42. These protrusions or brackets enable the mounting post 42 to be secured to the local floor and ceiling, being floor slabs 32 as illustrated in FIG. 2. The protrusions or brackets 52 may be provided with through-holes 54 as most clearly seen in FIG. 6 and FIG. 11. At least some of these through-holes may be in the form of slots to allow tolerance in location of mounting studs 60. Mounting studs 60 are attached to the local floor and ceiling by any appropriate conventional manner For example, if reinforced concrete floor slabs are used, holes may be drilled, and chemical anchors used to bond threaded rods into the concrete. Example chemical anchors include Fischer “Superbond” resin. In an exemplary embodiment, the threaded rods, like all the fixings described herein are of a material which does not deteriorate when exposed to rain: examples include galvanized treated steel and stainless steel.

As illustrated in the drawings, the charger 50 may be attached to lower section 421 of the mounting post 42. This may be by bolts, brazed studs or other fixings as appropriate. Cables to and from the charger 50 should be routed internally within the mounting post 42 for ease of installation, protection from damage and for aesthetic effect. Cables may be led through an opening in a wall of the lower section 421 of the mounting post, into the charger 50. Such opening is hidden by the charger 50 in the illustrated embodiment.

FIGS. 4, 5, 10, 11 show cable access openings 56 in walls of upper section 422 and lower section 421. As shown in FIG. 10, in an exemplary embodiment, the cable access openings 56 are located in a rear wall of the mounting post 42, this is, directed away from a user of the charger 50, and near to upper and lower extremities of the mounting post 42. This provides maximum protection for the cables. The cable access openings 56 also provide ventilation to the interior of the mounting post 42, which helps to ensure that any rainwater ingress has a chance to dry. The cable access openings 56 allow cables to enter and leave the interior of the mounting post 42, to access the charger 50, or to pass from one floor to another. In an exemplary embodiment, plastic caps of suitable dimensions may be provided to close openings 56 if desired.

In some embodiments of the present disclosure, the charger 50 is omitted, and the mounting post 42 is used as a cable conduit to pass cable from one floor to another.

In an exemplary embodiment, the power cable to the charger is either steel wire armored cable or other robust cable suitable for the application. There will always be at least one cable to the charger to provide power but supplementary cables may also be provided, for example to carry communications. These supplementary cables may either be separate cables or extra cores provided within the power cable.

Although not visible in the drawings, there will be apertures in the front wall of the mounting post 42, in lower section 421 in the illustrated embodiment, to allow mounting of the charger 50. There would typically be provided a large hole, for example 35 mm diameter, for power cables to pass from the interior of the mounting post 42 to the interior of charger 50. Smaller holes will also typically be provided, to enable physical attachment of the charger to the post, by bolts, threaded holes, or other suitable fasters. Alternatively, threaded studs may be brazed to the mounting post 42 and pass through holes in the back of charger 50. These holes may be predrilled to support the charger or may be drilled on site during the installation process. In the UK, such chargers 50 for electric vehicles must be mounted at a height of nominally 1.2 m, typically between 0.75 m and 1.2 m, according to building regulations and BS 8300 and to allow wheelchair users to operate the charger.

In the illustrated embodiment, the mounting post 42, made up of lower section 421 and upper section 422, has a slim rectangular cross-section, and brackets 52 with mounting holes 54 are located so as to maintain the slim profile. As illustrated in FIG. 2, such a slim rectangular profile helps in locating the mounting post 42 behind the barrier 36 in a car park. In other embodiments, the mounting post 42, made up of lower section 421 and upper section 422, may have other cross sections, such as square or rectangular.

In a typical installation sequence, upper section 422 and lower section are assembled together, one sliding inside the other, and nuts and bolts 45, 46 placed on studs 44 but not fully tightened. Threaded studs or bolt anchors are located at appropriate positions in the local floor and ceiling, which are typically reinforced concrete slabs. Cables are threaded through cable access holes 56 and through a hole to access the charger 50 where required. The mounting post may then be positioned by locating holes 54 over the threaded studs 60 or bolt anchors on the floor, with nuts 62 and washers 64 placed on the threaded studs 60, or bolts inserted through holes 54 into the bolt anchors, but not fully tightened. Similarly, locating holes 54 of upper section 422 are located over threaded studs 60 or bolt anchors on the floor, with nuts 62 and washers 64 placed on the threaded studs 60, or bolts inserted through holes 54 into the bolt anchors, but not fully tightened. This will require some relative movement of the upper section 422 and lower section 421 to bring mounting post 42 to the correct length to span the gap between local floor and ceiling. With nuts and washers 62, 64; 45, 46 all in place, all nuts may be tightened to firmly attach the mounting post 42 in place, and to fix its length. Other equivalent fastenings may of course be used. Depending on the location of installation, security fasteners such as shear nuts may be employed.

The charger 50, conventional in itself, may then be mounted to the mounting post 42 as desired and the cables fastened to connectors or electrical terminals within the body of the charger 50.

Example materials according to exemplary embodiments may include the following. The mounting post 42 may be of steel, stainless steel or aluminum and may be powder coated or galvanized and/or painted to resist corrosion. Fixings may be of galvanized or stainless steel, or brass. The mounting post 42 may be made from glass reinforced plastic but this would be initially quite expensive, to provide tooling, and would not be as environmentally friendly, that is to say recyclable, as a metal structure.

In certain embodiments of the disclosure, two or more chargers for electric vehicles could be mounted to one support, one front, one rear and/or one above the other.

In some embodiments, lighting may be provided, attached to the mounting post 42 and supplied with power by a cable passing through the interior of the mounting post 42. Such lighting may provide general illumination, targeted illumination to assist a user of the charger 50 and/or may be colored or otherwise encoded to indicate a status of the charger, such as available/in use/out of order. Signage may also be applied to the post to indicate parking restrictions, tariffs or providing information.

Alternative upper sections 422 with different lengths can be provided, to allow a fitter to select according to local floor-to-ceiling height. Alternatively, a long upper section 422 may be cut down if found too long for local floor-to-ceiling height.

In other embodiments, the lower section 421 may be slotted 43 and of larger cross-section than the upper section 422.

The charger 50 may be attached either to the lower section 421 or to the upper section 422.

In other embodiments, a suitably shaped bracket may be employed to attach the mounting post to structures such as low height walls 34, which may complement or replace the securing of the mounting post at the top and/or bottom, and may make installation easier, according to the specific site.

In other embodiments, some or all of the brackets 52 may be oriented vertically, and the upper and/or lower extremities may be secured to a wall of other vertical surface, if appropriate for the installation location.

The present disclosure accordingly provides a mounting post of variable height, comprising upper and lower parts that slide and are movable within one another. During installation, the mounting post is mounted top and bottom to fixed surfaces and the upper and lower parts are fixed relative to one another by a suitable fastening. In an exemplary embodiment, the mounting post provides cable access holes near its upper and lower extremities. While the mounting posts of the present disclosure are described herein with reference to chargers for electric vehicles, electrical equipment other than chargers for electric vehicles, or indeed no electrical equipment at all, may be mounted on the mounting post of the present disclosure.

It should be noted that the terms “first”, “second”, etc. in the description, claims and abovementioned drawings of the present disclosure are used to distinguish between similar objects, but not necessarily used to describe a specific order or sequence. It should be understood that data used in this way can be interchanged as appropriate so that the embodiments of the present disclosure described here can be implemented in an order other than those shown or described here. In addition, the terms “comprise” and “have” and any variants thereof are intended to cover non-exclusive inclusion. For example, a process, method, system, product or equipment comprising a series of steps or modules or units is not necessarily limited to those steps or modules or units which are clearly listed, but may comprise other steps or modules or units which are not clearly listed or are intrinsic to such processes, methods, products or equipment.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The exemplary embodiments described herein are provided for illustrative purposes, and are not limiting. Other exemplary embodiments are possible, and modifications may be made to the exemplary embodiments. Therefore, the specification is not meant to limit the disclosure. Rather, the scope of the disclosure is defined only in accordance with the following claims and their equivalents.

1. An assembly comprising:
a mounting post configured to be securely attached between a floor and ceiling, the mounting post including:
first and second hollow sections, the first hollow section having larger internal cross-sectional dimensions than the second hollow section, wherein the first hollow section is configured to slide over the second hollow section to form a mounting post of variable length, and wherein the two hollow sections each include a cable access hole at respective upper and lower extremities of the mounting post; one of the first and second hollow sections including a further cable access hole configured to allow a cable to pass therethrough to supply power to equipment mounted on the mounting post, and
attachment means for attachment of the mounting post to a structure and fixing means for fixing the length of the mounting post; and
a charger for electric vehicles that includes a cable configured to pass through the further cable access hole, extending from the charger into an interior of the mounting post.

2. The assembly according to claim 1, wherein the first hollow section further comprises a slot provided in a wall of the first hollow section of the mounting post, the fastening means extending through the slot, forming the fixing means for fixing the length of the mounting post.

3. The assembly according to claim 1, wherein the attachment means comprise brackets at extremities of the mounting post, the brackets each including a through-hole configured to accept one or more fasteners to attach the respective brackets to the floor and ceiling.

4. An assembly comprising:
a first hollow section;
a second hollow section, the first hollow section having larger internal cross-sectional dimensions than the second hollow section, wherein the first hollow section is configured to slide over the second hollow section to form a mounting post of variable length, the first and second hollow sections forming a mounting post configured to be attached between first and second surfaces;
a first mount point at an end of the first hollow section and configured to attached the first hollow section to the first surface;
a second mount point at an end of the second hollow section and configured to attached the second hollow section to the second surface; and
a lock configured to fix the length of the mounting post.

5. The assembly according to claim 4, wherein:
the first hollow section further comprises a first access hole at the end of the first hollow section, the first access hole being configured to allow access to a hollow interior of the first hollow section; and/or
the second hollow section further comprises a second access hole at the end of the second hollow section, the second access hole being configured to allow access to a hollow interior of the second hollow section.

6. The assembly according to claim 4, further comprising an electronic device mounted to the second hollow section.

7. The assembly according to claim 6, wherein electronic device is a charger configured to charge an electric vehicle.

8. The assembly according to claim 6, wherein the second hollow section further comprises a device access hole configured to allow the electronic device mounted on the second hollow section access to a hollow interior of the second hollow section.

9. The assembly according to claim 8, wherein the mounting post is configured to house a cable of the electronic device that accesses the hollow interior of the first hollow section and/or the hollow interior of the second hollow section via the device access hole.

10. The assembly according to claim 4, wherein:
the first hollow section further comprises a first access hole at the end of the first hollow section, the first access hole being configured to allow access to a hollow interior of the first hollow section; and/or the second hollow section further comprises a second access hole at the end of the second hollow section, the second access hole being configured to allow access to a hollow interior of the second hollow section; and
the second hollow section further comprises a device access hole configured to allow access to the hollow interior of the second hollow section, the device access hole being configured to be in communication with:
the first access hole via the hollow interior of the first hollow section and the hollow interior of the second hollow section, and/or
the second access hole via the hollow interior of the second hollow section.

11. The assembly according to claim 4, further comprising an electronic device mounted to the first hollow section.

12. The assembly according to claim 11, wherein electronic device is a charger configured to charge an electric vehicle.

13. The assembly according to claim 11, wherein the first hollow section further comprises a device access hole configured to allow the electronic device mounted on the first hollow section access to a hollow interior of the first hollow section.

14. The assembly according to claim 4, wherein the first hollow section further comprises a slot provided in a wall of the first hollow section, the lock extending through the slot to fix the length of the mounting post.

15. The assembly according to claim 4, wherein:
the first mount point comprises a first bracket having a through-hole configured to accept one or more fasteners configured to attach the first bracket to the first surface;
the second mount point comprises a second bracket having a through-hole configured to accept one or more fasteners configured to attach the second bracket to the second surface.

16. The assembly according to claim 4, wherein:
the first hollow section further comprises a first access hole at the end of the first hollow section, the first access hole being configured to allow access to a hollow interior of the first hollow section;
the second hollow section further comprises a second access hole at the end of the second hollow section, the second access hole being configured to allow access to a hollow interior of the second hollow section; and
the first access hole is in communication with the second access hole via the hollow interior of the first hollow section and the hollow interior of the second hollow section.

17. The assembly according to claim 4, wherein the lock is fixed to the second hollow section and selectively fixed to the first hollow section to fix the length of the mounting post.

18. A method for mounting a charger for electric vehicles, comprising:
providing a mounting post including:
first and second hollow sections, the first hollow section having larger internal cross-sectional dimensions than the second hollow section, the first hollow section being configured to slide over the second hollow section to produce a mounting post of variable length,
attachment means for attachment of the mounting post to a structure and length fixing means for fixing the length of the mounting post, the mounting post being configured to securely attach between a local floor and ceiling, the two hollow sections each provided with a cable access hole at respective upper and lower extremities of the mounting post, wherein one of the first and second hollow sections includes a further cable access hole configured to allow a cable to pass therethrough to supply power to equipment mounted on the mounting post;
providing fixing means attached to local floor and ceiling;
attaching the mounting post to the fixing means; and
attaching the charger for electric vehicles to the mounting post.

19. The method according to claim 18, further comprising:
passing a cable through at least one of the cable access holes and the further access hole; and
attaching the cable to charger.

20. The method according to claim 18, further comprising:
adjusting a length of the mounting post; and
fixing the length of the mounting post using the length fixing means.
